(19) United States
(12) Patent Application Publication
(10) Pub. No.: US 2016/0224325 A1
(43) Pub. Date: Aug. 4, 2016

(54) HIDING COMPILATION LATENCY

(71) Applicant: Mentor Graphics Corporation, Wilsonville, OR (US)

(72) Inventors: Nathan Sidwell, Brighton, MA (US); Glenn Perry, Oakland, CA (US)

(21) Appl. No.: 14/608,640

(22) Filed: Jan. 29, 2015

(51) Int. Cl. G06F 9/45; G06F 9/455

(52) U.S. Cl. CPC G06F 8/4441; G06F 9/4552

(57) ABSTRACT

This application discloses a computing system configured to convert a virtual machine instruction set corresponding to a downloadable application into native code specific to the computing system. Prior to completion of the conversion of the virtual machine instruction set into native code specific to the computing system, the computing system can utilize a process virtual machine to execute the virtual machine instruction set to implement the downloadable application. After completion of the conversion of the virtual machine instruction set into native code specific to the computing system, the computing system can switch the execution of the virtual machine instruction set with the process virtual machine to execution of the native code by the computing system to implement the downloadable application.

### TECHNICAL FIELD

This application is generally related to execution of downloadable applications by a processing system and, more specifically, to hiding compilation latency for the downloadable applications.

### BACKGROUND

Downloadable applications or “apps,” which can run or be executed on various computing systems, for example, smart phones, tablets, computers, or the like, have become ubiquitous in recent years. Since these computing systems can have different underlying platforms, such as different hardware architectures and/or different operating systems, they often utilize a process virtual machine—sometimes called an application virtual machine or managed runtime environment (MRE)—to provide a platform-independent programming environment for the execution of these downloadable applications. Each of the computing systems can implement a process virtual machine as an application inside their host operating system, which can perform just-in-time (JIT) compilation of the downloadable application into hardware-specific code, allowing the downloadable applications to execute similarly on any platform. JIT compilers typically translate parts of the program on an as-needed basis, maintaining a cache of translated portions.

While the ability of the process virtual machine to abstract the underlying hardware or operating system of the computing systems provides a bridge between the various hardware platforms and a common programming environment, this abstraction comes at the cost of slower performance or execution of the downloadable application. To combat this reduced performance, some computing systems have switched from just-in-time compilation to ahead-of-time compilation, which transforms the virtual instruction sets for the downloadable applications specified for the process virtual machine into native code for the specific underlying platform at the time of installation of the downloadable application in the computing system. The faster performance provided by executing native code, however, comes at the cost of a longer installation time, which delays an initial launching of the downloadable application beyond when a virtual process machine could launch the downloadable application.

### SUMMARY

This application discloses a computing system configured to convert a virtual machine instruction set corresponding to a downloadable application into native code specific to the computing system. Prior to completion of the conversion of the virtual machine instruction set into native code specific to the computing system, the computing system can utilize a process virtual machine to execute the virtual machine instruction set. After completion of the conversion of the virtual machine instruction set into native code specific to the computing system, the computing system can switch the execution of the virtual machine instruction set by the process virtual machine to execution of the native code by the underlying computing system itself. Embodiments of hiding latency associated with converting virtual machine code into hardware-specific native code are described in greater detail below.

### DESCRIPTION OF THE DRAWINGS

FIGS. 1 and 2 illustrate an example of a computer system of the type that may be used to implement various embodiments of the invention.

FIG. 3 illustrates an example computing system to implement a compilation latency hiding process according to various embodiments of the invention.

FIG. 4 illustrates an example distribution flow for a downloadable application according to various embodiments of the invention.

FIG. 5 illustrates a flowchart showing an example process for hiding latency associated with compiling virtual machine code into hardware-specific native code according to various examples of the invention.

FIG. 6 illustrates a flowchart showing another example process for hiding latency associated with compiling virtual machine code into hardware-specific native code according to various examples of the invention.

### DETAILED DESCRIPTION

### Illustrative Operating Environment

The execution of various downloadable applications according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described.

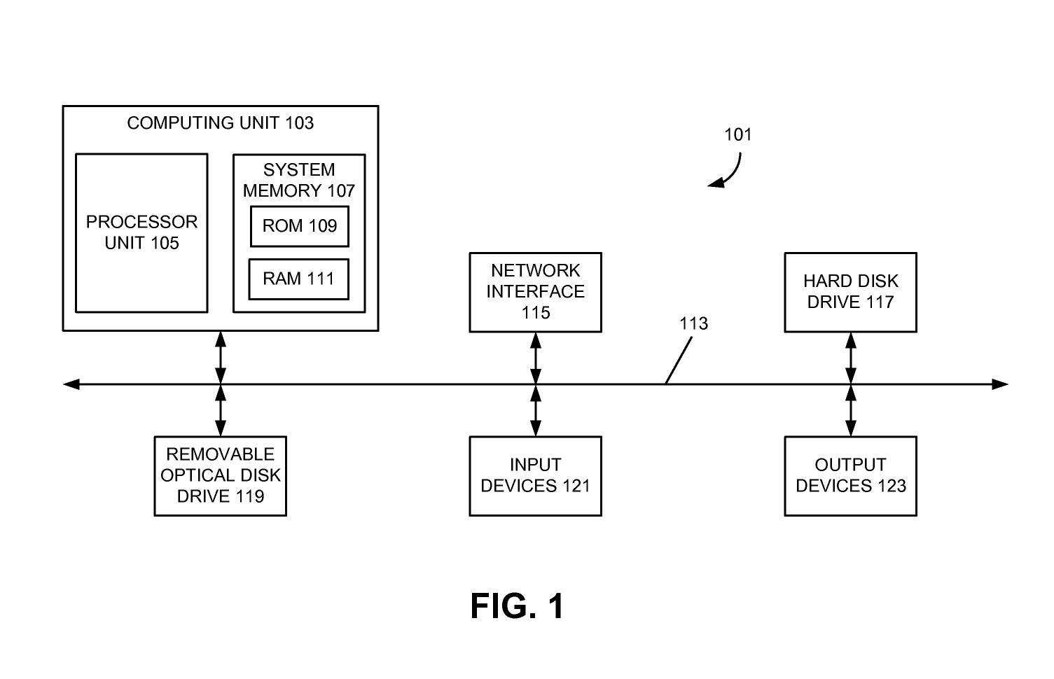

Various examples of the invention may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

With some implementations of the invention, the processor unit 105 can have more than one processor core. Accordingly, FIG. 2 illustrates an example of a multi-core processor unit 105 that may be employed with various embodiments of the invention. As seen in this figure, the processor unit 105 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 113. Similarly, the memory controller 211 controls the exchange of information between the processor unit 201 and the system memory 107. With some implementations of the invention, the processor units 201 may include additional components, such as a high-level cache memory accessible shared by the processor cores 201.

It also should be appreciated that the description of the computer network illustrated in FIG. 1 and FIG. 2 is provided as an example only, and it not intended to suggest any limitation as to the scope of use or functionality of alternate embodiments of the invention.

### Illustrative Techniques for Hiding Compilation Latency

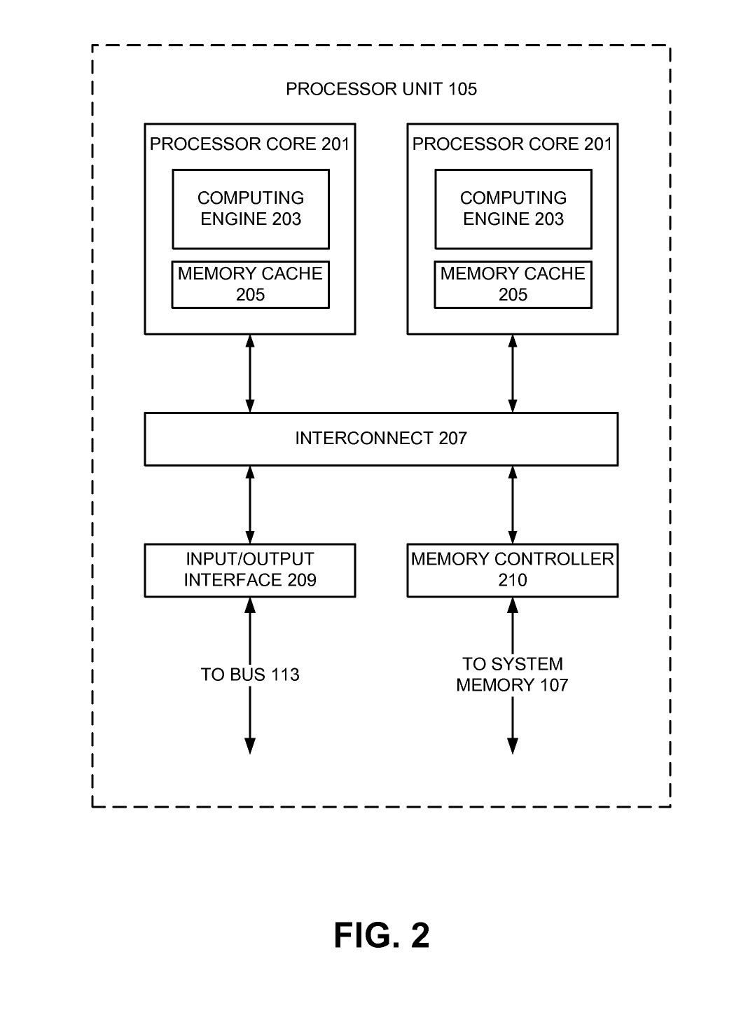

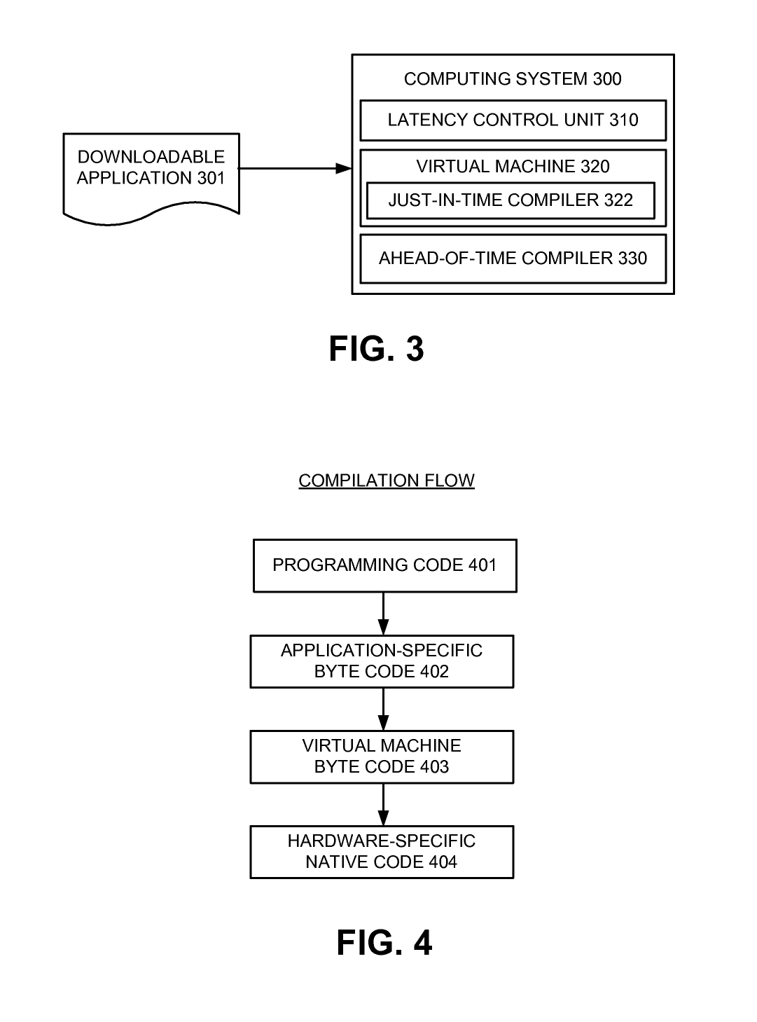

FIG. 3 illustrates an example computing system 300 to implement a compilation latency hiding process according to various embodiments of the invention. Referring to FIG. 3, the computing system 300, which may be incorporated in a smart phone, tablet, computer, or other electronic system, can receive a downloadable application 301, for example, from a remote server system over a network, from a memory system, or the like. The downloadable application 301 can have a platform-independent format, which the computing system 300 can compile into native machine code specific to a platform of the computing system 300, such as its hardware architecture, its operating system, or the like. The computing system 300 can execute the native machine code, which can allow the computing system 300 to launch and run the downloadable application 301. An example compilation flow for the downloadable application 301 is described below in greater detail with reference to FIG. 4.

FIG. 4 illustrates an example compilation flow for a downloadable application according to various embodiments of the invention. Referring to FIG. 4, the downloadable application can be written as programming code 401, for example, in a programming language, such as Java, C++, or the like. The programming code 401 can be compiled into application-specific byte code 402. For example, when the programming code 401 is written in a Java programming language, the application-specific byte code 402 can be a Java byte code. While a computing system can run the downloadable application by executing the Java byte code in a Java virtual machine, the indirect nature of the execution of the downloadable application by the Java virtual machine can impede run-time performance.

To improve run-time performance, many computing systems instead elect to execute a hardware-specific byte code 404, such as native machine code. One technique to generate the hardware-specific byte code 404 is for the computing system to implement a virtual machine having a just-in-time compiler. Parts of the application-specific byte code 402 can be converted or translated into a virtual machine byte code 403, for example, on an as-needed basis, which the just-in-time compiler implemented by the computing system can compile on-the-fly into hardware-specific native code 404. The just-in-time compiler performs its compilation, possibly multiple times, of the virtual machine byte code 403 into hardware-specific native code 404 during each execution of the downloadable application on the computing system. A cache of translated portions is maintained, and retranslation might be necessary if the cache replacement has evicted a block. In some examples, the virtual machine having the just-in-time compiler can be a Dalvik virtual machine, and the virtual machine byte code 403 can be Dalvik byte code, for example, in a Dalvik executable file (.dex) format or an optimized Dalvik executable file (.odex) format.

Another technique to generate the hardware-specific byte code 404 is for the computing system to implement an ahead-of-time compiler, which can compile the virtual machine byte code 403 into hardware-specific native code 404, for example, during the installation process. Once the ahead-of-time compiler has completed generation of the hardware-specific native code 404, the computing system can launch or run the downloadable application by executing the hardware-specific native code 404 already compiled by the ahead-of-time compiler.

While these compilers can generate hardware-specific native code 404 for direct execution by the computing system, there are tradeoffs for using either one. For example, utilization of the ahead-of-time compiler can provide better run-time performance than when utilizing the just-in-time compiler, as all of the compilation is performed once at installation and not multiple times on-the-fly while running the downloadable application. This can allow more aggressive optimizations that would take unacceptably long within the JIT, or perhaps require more global program analysis than can be done in the JIT context. On the other hand, since, with the ahead-of-time compiler, the computing system compiles the virtual machine byte code 403 into hardware-specific native code 404 prior to being able to launch or execution of the downloadable application, utilization of the ahead-of-time compiler can add a latency or a delay for an initial launch and run of the downloadable application with hardware-specific native code 404 generated by the ahead-of-time compiler.

Referring back to FIG. 3, the computing system 300 can receive the downloadable application 301 that, in some embodiments, can be in the form of virtual machine byte code, similar to virtual machine byte code 403 in FIG. 4, which can be installed in the computing system 300. The computing system 300 can implement a virtual machine 320 that can launch the downloadable application 301 by executing the virtual machine byte code.

The virtual machine 320 can include a just-in-time compiler 322 to compile the virtual machine byte code into native machine code specific to the platform of the computing system 300. The computing system 300 can execute the native machine code generated by the just-in-time compiler 322, which can launch and/or run the downloadable application 301. In some embodiments, when the downloadable application 301 corresponds to a Dalvik byte code, the computing system 300 can implement a Dalvik virtual machine as virtual machine 320, which can execute the Dalvik byte code to launch and run the downloadable application 301.

The computing system 300 can include or implement an ahead-of-time compiler 330, which can compile the downloadable application 301 into native machine code specific to the platform of the computing system 300. Once that compilation has been completed, the computing system 300 can execute the native machine code generated by the ahead-of-time compiler 330, which can launch and run the downloadable application 301.

Since the computing system 300 waits until the ahead-of-time compiler 330 completes its compilation of the downloadable application 301 to execute the native machine code generated by the ahead-of-time compiler 320, there can be a latency or delay associated with that initial launch of the downloadable application 301 compared to when the computing system 300 launches the downloadable application 301 with the virtual machine 320. The computing system 300 can include a latency control unit 310 to prompt the computing system 300 to launch and run the downloadable application 301 prior to completion of compilation by the ahead-of-time compiler 330, which can hide the initial launch latency caused by utilizing the ahead-of-time compiler 330.

In some embodiments, when the computing system 300 determines to perform ahead-of-time compilation of the downloadable application 301, for example, with the ahead-of-time compiler 330, the latency control unit 310 can direct the computing system 300 to also implement a virtual machine 320 and associated just-in-time compiler 322, which can allow the computing system 300 launch and run the downloadable application 301 directly from the virtual machine byte code. By launching and running the downloadable application 301 with the virtual machine byte code, rather than waiting for the ahead-of-time compiler 330 to complete its compilation of the virtual machine byte code into native machine code, the computing system 300 can eliminate the delay to initial launch and execution of the downloadable application 301.

In other embodiments, when the computing system 300 determines to perform ahead-of-time compilation of the downloadable application 301, for example, with the ahead-of-time compiler 330, the latency control unit 310 can direct the computing system 300 to generate multiple different versions of the native machine code with the ahead-of-time compilation. Since ahead-of-time compilation techniques can vary—with some techniques having quicker compilation time, but generating native machine code with reduced runtime performance compared to other techniques—the latency control unit 310 can direct the computing system 300 to generate multiple different versions of the native machine code corresponding to the downloadable application 301 that tradeoff the compilation time and runtime performance. When the computing system 300 has completed compilation of one of those versions, the latency control unit 310 can direct the computing system 300 to launch the downloadable application 301 with the native machine code corresponding to the completed version, while the computing system 300 continues its compilation for the other version(s) of the native machine code with the ahead-of-time compiler 330.

After the computing system 300 has completed its ahead-of-time compilation (or additional versions of the native machine code) for the downloadable application 301, the latency control unit 310 also can prompt the computing system 300 to selectively switch to native machine code compiled with the ahead-of-time compilation based on runtime performance for the downloadable application 301. In some examples, the latency control unit 310 can prompt the computing system 300 to cease executing the downloadable application 301, for example, with the virtual machine 320, and re-launch the downloadable application 301 by executing the native machine code compiled with the ahead-of-time compilation having better runtime performance. Rather than force a shut down and re-start of the downloadable application 301, the latency control unit 310, in some embodiments, can present a message, for example, in a display window, which can allow for selective re-launch of the downloadable application 301 in response to user input.

In some embodiments, the latency control unit 310 can prompt the computing system 300 to interleave virtual machine execution of the downloadable application 301 with execution of the native machine code compiled with the ahead-of-time compilation. For example, the latency control unit 310 can identify different functions in the downloadable application 301 and boundaries between the functions, which the computing system 300 can leverage this knowledge of the functional boundaries to jump between virtual machine execution of the downloadable application 301 with execution of the native machine code compiled with the ahead-of-time compilation. In some cases, when the computing system 300, executing the virtual machine byte code with the virtual machine 320, calls a new function, the latency control unit 310 can direct the computing system 300 to execute that function with the native machine code compiled with the ahead-of-time compilation. This can allow the computing system 300 the ability to seamlessly provide increased runtime performance provided by the native machine code compiled with the ahead-of-time compilation without having to re-launch the downloadable application 301. The computing system 300 can perform similar switching between multiple different versions of machine or native code generated with the ahead-of-time compiler 330, for example, based, at least in part, on runtime performance for the downloadable application 301 by the computing system 300.

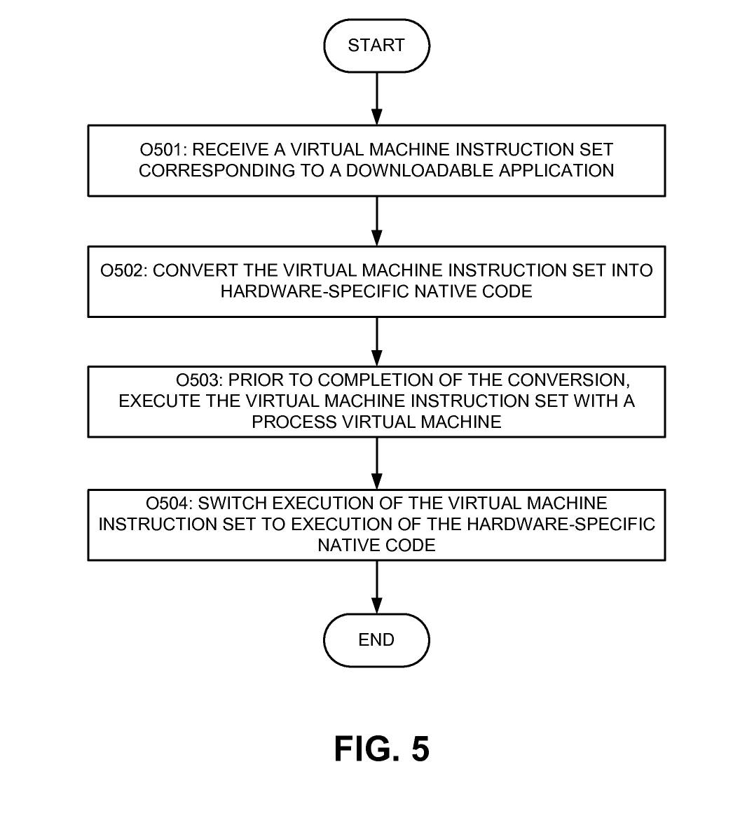

FIG. 5 illustrates a flowchart showing an example process for hiding latency associated with compilation of virtual machine code into hardware-specific native code according to various examples of the invention. Referring to FIG. 5, in a block 501, a computing system can receive a virtual machine instruction set corresponding to a downloadable application. In some embodiments, the virtual machine instruction set can be Dalvik byte code, for example, in a Dalvik executable file (.dex) format or an optimized Dalvik executable file (.odex) format.

In a block 502, the computing system can convert the virtual machine instruction set into hardware-specific native code, for example, with the ahead-of-time compiler of the computing system. In some embodiments, the ahead-of-time compiler can generate the hardware-specific native code for the computing system at the time of installation of the downloadable application.

In a block 503, while the computing system utilizes the ahead-of-time compiler to convert the virtual machine instruction set into hardware-specific native code, the computing system can execute the virtual machine instruction set with a process virtual machine. The computing system can implement a just-in-time compiler in the process virtual machine to compile the virtual machine instruction set into the hardware-specific native code on-the-fly as the computing system executes the downloadable application. Since the process virtual machine includes a just-in-timer compiler, the computing system can launch and run the downloadable application through the execution of the virtual machine instruction set with the process virtual machine. In some examples, the process virtual machine having the just-in-time compiler can be a Dalvik virtual machine capable of executing Dalvik byte code, for example, in a Dalvik executable file (.dex) format or an optimized Dalvik executable file (.odex) format.

In a block 504, the computing system can switch execution of the virtual machine instruction set to execution of the hardware-specific native code. After the computing system has completed its ahead-of-time compilation for the downloadable application, the computing system can selectively switch to between executing the virtual machine instruction set with the process virtual machine and executing the hardware-specific native code compiled with the ahead-of-time compilation, for example, based on runtime performance for the downloadable application. In some examples, the computing system can cease executing the downloadable application, for example, with the process virtual machine, and re-launch the downloadable application. Rather than force a shut down and re-start of the downloadable application, the computing system, in some embodiments, can present a message, for example, in a display window, which can allow for selective re-launch of the downloadable application in response to user input.

In some embodiments, the computing system can interleave execution of the virtual machine instruction set by the process virtual machine with execution of the hardware-specific native code compiled with the ahead-of-time compilation. For example, the computing system can jump between virtual machine execution of the downloadable application and execution of the hardware-specific native code compiled with the ahead-of-time compilation at functional boundaries in the downloadable application.

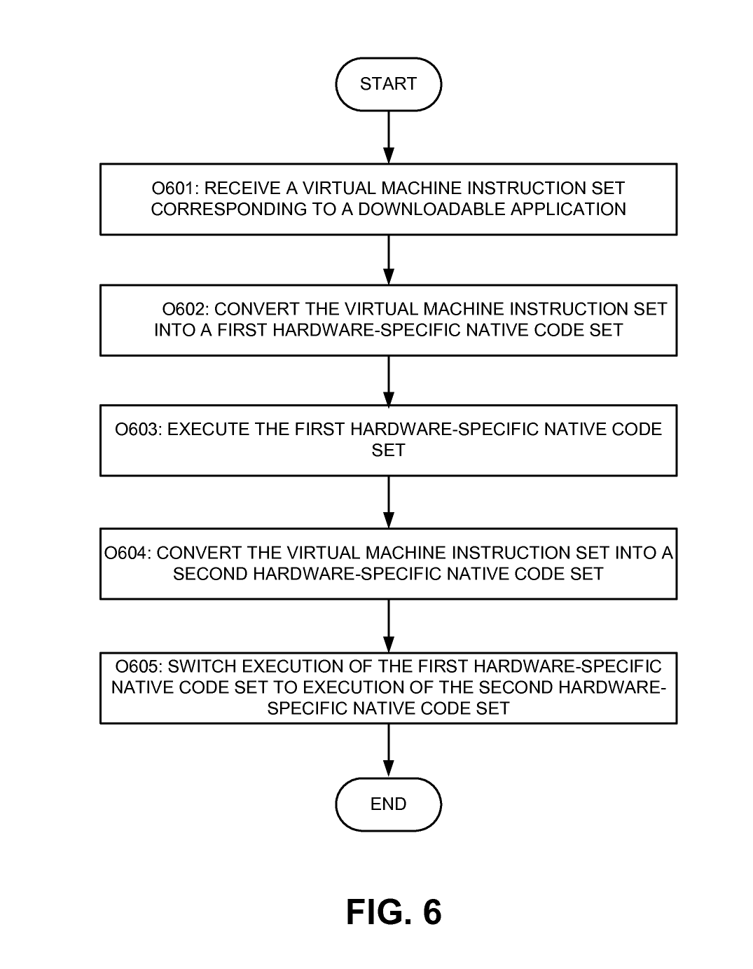

FIG. 6 illustrates a flowchart showing another example process for hiding latency associated with converting virtual machine code into hardware-specific native code according to various examples of the invention. Referring to FIG. 6, in a block 601, a computing system can receive a virtual machine instruction set corresponding to a downloadable application. In some embodiments, the virtual machine instruction set can be Dalvik byte code, for example, in a Dalvik executable file (.dex) format or an optimized Dalvik executable file (.odex) format.

In a block 602, the computing system can convert the virtual machine instruction set into a first hardware-specific native code, and in a block 603, the computing system can execute the first hardware-specific native code, which can launch and run the corresponding downloadable application. The computing system can utilize an ahead-of-time compiler to compile the virtual machine instruction set into the first hardware-specific native code. Once the computing system completes the ahead-of-time compilation, the resulting first hardware-specific native code can be installed in the computing system. In some embodiments, since the type of ahead-of-time compilation can vary, for example, trading-off compilation time of first hardware-specific native code and runtime performance of downloadable application resulting from the execution the first hardware-specific native code, the computing system can compile the virtual machine instruction set into the first hardware-specific native code utilizing an ahead-of-time compilation technique that favors compilation time over runtime performance.

In a block 604, the computing system can convert the virtual machine instruction set into a second hardware-specific native code. The computing system can utilize the ahead-of-time compiler to compile the virtual machine instruction set into the second hardware-specific native code. Once the computing system completes the ahead-of-time compilation, the resulting second hardware-specific native code can be installed in the computing system. In some embodiments, since the type of ahead-of-time compilation can vary, for example, trading-off compilation time of second hardware-specific native code and runtime performance of downloadable application resulting from the execution the second hardware-specific native code, the computing system can compile the virtual machine instruction set into the second hardware-specific native code utilizing an ahead-of-time compilation technique that favors runtime performance over compilation time.

In a block 605, the computing system can switch execution of the first hardware-specific native code to execution of the second hardware-specific native code. After the computing system has completed its ahead-of-time compilation that generates the second hardware-specific native code, the computing system can selectively switch to between executing the first hardware-specific native code and executing the second hardware-specific native code. In some examples, the computing system can cease executing the first hardware-specific native code, and re-launch the downloadable application by executing the second hardware-specific native code. Rather than force a shut down and re-start of the downloadable application, the computing system, in some embodiments, can present a message, for example, in a display window, which can allow for selective re-launch of the downloadable application in response to user input.

In some embodiments, the computing system can interleave execution of the first hardware-specific native code with execution of the second hardware-specific native code. For example, the computing system can jump between execution of the first hardware-specific native code and execution of the second hardware-specific native code at functional boundaries in the downloadable application.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to certain processes, it should be appreciated that various examples of the invention may be implemented using any desired combination of processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
converting, by a computing system, a virtual machine instruction set corresponding to a downloadable application into native code specific to a hardware platform of the computing system; and
prior to completion of the conversion, launching, by the computing system, the downloadable application, which includes executing the virtual machine instruction set with a process virtual machine.

2. The method of claim 1, further comprising:
after the completion of the conversion, ceasing, by the computing system, execution of the virtual machine instruction set with the process virtual machine; and
re-launching, by the computing system, the downloadable application, which includes executing the native code specific to the hardware platform of the computing system.

3. The method of claim 2, further comprising presenting, by the computing system, a prompt in a display window that, when selected based on user input, is configured to prompt the ceasing of the execution of the virtual machine instruction set and the re-launching of the downloadable application.

4. The method of claim 1, further comprising switching, by the computing system, the execution of the virtual machine instruction set with the process virtual machine to execution of the native code by the computing system after the completion of the conversion and without having to re-launch the downloadable application.

5. The method of claim 4, wherein switching the execution of the virtual machine instruction set to the execution of the native code further comprises:
identifying a functional call in the execution of the virtual machine instruction set; and
executing a portion of the native code corresponding to a function associated with the functional call.

6. The method of claim 1, wherein the process virtual machine is a Dalvik virtual machine, and the virtual machine instruction set is Dalvik byte code.

7. The method of claim 1, wherein the virtual machine instruction set is an intermediate representation by a compiler or a non-native instruction set for another processor implementation.

8. A system comprising:
a memory system configured to store computer-executable instructions; and
a computing system, in response to execution of the computer-executable instructions, is configured to:
convert a virtual machine instruction set corresponding to a downloadable application into native code specific to a hardware platform of the computing system; and
launch the downloadable application prior to completion of the conversion, which includes execution of the virtual machine instruction set with a process virtual machine.

9. The system of claim 8, wherein the computing system, in response to execution of the computer-executable instructions, is further configured to:
cease execution of the virtual machine instruction set with the process virtual machine after the completion of the conversion; and
re-launch the downloadable application, which includes execution of the native code specific to the hardware platform of the computing system.

10. The system of claim 8, wherein the computing system, in response to execution of the computer-executable instructions, is further configured to present a prompt in a display window that, when selected based on user input, is configured to prompt the ceasing of the execution of the virtual machine instruction set and the re-launching of the downloadable application.

11. The system of claim 8, wherein the computing system, in response to execution of the computer-executable instructions, is further configured to switch the execution of the virtual machine instruction set with the process virtual machine to execution of the native code by the computing system after the completion of the conversion and without having to re-launch the downloadable application.

12. The system of claim 11, wherein the computing system, in response to execution of the computer-executable instructions, is further configured to:
identify a functional call in the execution of the virtual machine instruction set; and
execute a portion of the native code corresponding to a function associated with the functional call.

13. The system of claim 8, wherein the process virtual machine is a Dalvik virtual machine, and the virtual machine instruction set is Dalvik byte code.

14. The system of claim 8, wherein the virtual machine instruction set is an intermediate representation by a compiler or a non-native instruction set for another processor implementation.

15. An apparatus comprising at least one computer-readable memory device storing instructions configured to cause one or more processing devices to perform operations comprising:
converting a virtual machine instruction set corresponding to a downloadable application into a first native code set and a second native code set that are both specific to a hardware platform of the computing system;
launching the downloadable application, which includes executing the first native code set prior to completion of the conversion of the virtual machine instruction set into the second native code set; and
switching, by the computing system, the execution of the first native code set to an execution of the second native code set after completion of the conversion of the virtual machine instruction set into the second native code set.

16. The apparatus of claim 15, where switching the execution of the first native code set to an execution of the second native code set further comprises:
ceasing execution of the first native code set; and
re-launching the downloadable application, which includes executing the second native code set.

17. The apparatus of claim 15, further comprising prompt, by the computing system, a presentation in a display window that, when selected based on user input, is configured to prompt the ceasing of the execution of the first native code set and the re-launching of the downloadable application.

18. The apparatus of claim 15, where switching the execution of the first native code set to an execution of the second native code set further comprises:
identifying a functional call in the execution of the first native code set; and
executing a portion of the second native code set corresponding to a function associated with the functional call without having to re-launch the downloadable application.

19. The apparatus of claim 15, where switching the execution of the first native code set to an execution of the second native code set is performed

20. The apparatus of claim 15, wherein the conversion of the virtual machine instruction set into the first native code set is faster than the conversion of the virtual machine instruction set into the second native code set, while a run-time performance of the downloadable application is faster when executing the second native code set compared to the when executing the first native code set.
